(19) United States
(12) Patent Application Publication
(10) Pub. No.: US 2005/0143146 A1
(43) Pub. Date: Jun. 30, 2005

(54) System and method for reducing power consumption by a telematic terminal

(75) Inventor: Hyong-Kyun Kim, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/027,327

(22) Filed: Dec. 29, 2004

(30) Foreign Application Priority Data
Dec. 29, 2003 (KR) 10-2003-0099268

(51) Int. Cl. H04M 11/00; H04M 1/00; H04B 1/16; H04B 1/38

(52) U.S. Cl. 455/574; 455/343.1

(57) ABSTRACT

A system for reducing power consumption by a telematic terminal comprises a NAD (Network Access Device) processor having a processor core, a CIU (Communication Interface Unit), and a telematic terminal controller operatively coupled between the CIU and the NAD processor on board a vehicle. The controller and the NAD processor core are configured to be turned off and driven, respectively, in a power saving mode when the vehicle ignition is turned off. The power saving mode changes into a signal reception standby state after a pre-set period of time. The NAD processor operates normally during the signal reception standby state.

### CROSS-REFERENCE TO RELATED APPLICATIONS

Pursuant to 35 U.S.C. § 119(a), this application claims the benefit of earlier filing date and right of priority to Korean Patent Application No. 10-2003-0099268 filed on Dec. 29, 2003, the contents of which is hereby incorporated by reference in its entirety.

### BACKGROUND OF THE INVENTION

1. Field of the Invention

The present invention relates generally to the field of telematics, and more particularly to a system and method for reducing power consumption by a telematic terminal.

2. Description of the Related Art

The term “telematics” is an acronym for “telecommunication” and “informatics.” The term has evolved to refer to systems used in automobiles that combine wireless communication with GPS (Global Positioning System) tracking. GPS is a worldwide satellite navigational system formed by satellites that orbit the Earth at approximately 12,000 miles above the Earth's surface and make two complete orbits every 24 hours. The GPS satellites continuously transmit digital radio signals containing data on orbital location and exact time to Earth-bound receivers.

The term “telematics” has further evolved to refer to telecommunication functionality that originates or terminates in transportation vehicles. Lately, telematics has been receiving much attention in the field of information technology (IT). Particularly, an automobile equipped with an on-board telematic terminal can provide the driver with a wide variety of up-to-date information on car accidents, crime prevention, road and traffic conditions, or the like in real-time. The telematic terminal can wirelessly establish communication with an automobile service center when a traveling vehicle unexpectedly breaks down on the road.

Telematic terminals can also receive and display road map data via an on-board display unit, allow passengers to play computer games via a portable computer monitor installed in the back seats, and provide status information on major components of the vehicle to a central automobile service facility. Telematic terminals also allow a driver to use the Internet via voice commands while driving. Such a terminal can help locked-out drivers gain access to their vehicles by receiving and acting on a satellite “door unlock” signal from a vehicle service center.

FIG. 1 is a block diagram of a conventional telematic terminal 10. Telematic terminal 10 includes a NAD (Network Access Device) processor 11, a NAD power supply 12, a terminal controller 13, and a CIU (Communication Interface Unit) 15. NAD processor 11 is configured to process various call signals between a base station and the terminal using mobile (wireless) communication technology, as well as modulate/demodulate data signals. Terminal controller 13 is operatively coupled between CIU 15 and NAD processor 11, and is powered by a main power supply 16 (FIG. 1).

Terminal controller 13 communicates with NAD processor 11 via a UART (Universal Asynchronous Receiver Transmitter) connection. A software (S/W) timer 13a in terminal controller 13 is driven by a clock oscillator 14 (FIG. 1). A keep-alive power supply 18 supplies power to CIU 15 and a communication signal amplifier 17 (FIG. 1).

CIU 15 includes a CAN (Controller Area Network) physical layer interface 15a and a J1850 physical layer interface 15b, and is configured as a Class 2 Series communication device. Main power supply 16 is controlled by a communication signal combiner 19 which receives input from CIU 15 and communication signal amplifier 17.

Telematic terminal 10 operates in a reception standby power saving mode after the ignition of a vehicle equipped with telematic terminal 10 is turned off. In the reception standby power saving mode, operation is performed in ten-minute intervals whereby communication signals are being received from a base station for one minute after the ignition of the car is turned off with no communication signals being received from the base station for the remaining nine minutes. Such operation is performed continuously to limit power consumption as much as possible, as well as to extend the life of the vehicle battery or other power storage devices, such as the battery of the telematic terminal.

Specifically, NAD processor 11 receives current time information from a CDMA (Code Division Multiple Access)/PCS (Personal Communications Service) base station (not shown) and transmits the received time information to terminal controller 13. If the vehicle ignition is turned off, clock oscillator 14 drives software timer 13a whereby terminal controller 13 implements a power saving mode periodically according to a pre-set timing. In a reception standby state, terminal controller 13, NAD processor 11 and a RF (Radio Frequency) module (not shown) are driven for one minute to receive communication signals transmitted from the base station. For the remaining nine minutes, only the NAD processor core, the RF module core and the terminal controller core are driven in a power saving mode.

The simultaneous operation of terminal controller 13, NAD processor 11 and the RF module during a reception standby state causes large amounts of current to be consumed due to software timer 13a being integrated in terminal controller 13. However, vehicle battery capacity is somewhat limited. Thus, on-board telematic terminal 10 cannot operate for a prolonged period of time without draining the vehicle battery.

### SUMMARY OF THE INVENTION

In accordance with one aspect of the present invention, a system for reducing power consumption by a telematic terminal comprises a NAD (Network Access Device) processor having at least one processor core, a CIU (Communication Interface Unit), and a telematic terminal controller operatively coupled between the CIU and the NAD processor on board a vehicle. The telematic terminal controller and the NAD processor core are configured to be turned off and driven, respectively, in a power saving mode when the vehicle ignition is turned off. The power saving mode changes into a signal reception standby state after a pre-set period of time.

The NAD processor is adapted to operate normally during the signal reception standby state, whereby only the NAD processor core and an associated RF (Radio Frequency) module core are driven for the pre-set period of time when the vehicle ignition is turned off.

A first power supply is adapted to power the telematic terminal controller. The first power supply is controlled by a communication signal combiner which receives input from the CIU, the NAD processor and at least one communication signal amplifier.

A second power supply is adapted to power the NAD processor. The second power supply is turned on by the telematic terminal controller. The NAD processor includes a software timer being driven by a clock oscillator. The clock oscillator is operatively coupled to the NAD processor. The NAD processor drives the software timer based on time information transmitted from a base station and the clock oscillator during the power saving mode.

A third power supply is adapted to power the CIU and the communication signal amplifier. The third power supply may be a keep-alive power supply. The CIU may include at least one CAN (Controller Area Network) physical layer interface and at least one J1850 physical layer interface. The CIU may be configured as a Class 2 Series communication device. The telematic terminal controller communicates with the NAD processor via a UART (Universal Asynchronous Receiver Transmitter) connection.

In accordance with another aspect of the present invention, a system for reducing power consumption by a telematic terminal comprises a NAD (Network Access Device) processor having a core, a CIU (Communication Interface Unit), a PMIC (Power Management Integrated Circuit) having a core, and a telematic terminal controller operatively coupled between the CIU and the NAD processor on board a vehicle and being powered by the PMIC. The telematic terminal controller and the NAD and PMIC cores are configured to be turned off and driven, respectively, in a power saving mode when the vehicle ignition is turned off.

The power saving mode changed into a signal reception standby state after a pre-set period of time. The NAD processor and the PMIC operate normally during the signal reception standby state, whereby only the NAD and PMIC cores and an associated RF (Radio Frequency) module core are driven for the pre-set period of time when the vehicle ignition is turned off.

The PMIC includes a RTC (Real-Time Clock) unit. The PMIC is turned on by the telematic terminal controller. The PMIC drives the RTC unit based on time information received from the NAD processor and a clock oscillator that is operatively coupled to the PMIC. The NAD processor is configured to periodically change the reception standby state to the power saving mode on the basis of real-time information received from the RTC unit. The telematic terminal controller communicates with the NAD processor via a UART (Universal Asynchronous Receiver Transmitter) connection.

A first power supply is adapted to power the telematic terminal controller. The first power supply is controlled by a communication signal combiner which receives input from the CIU, the NAD processor and at least one communication signal amplifier.

A second power supply is adapted to power the CIU and the communication signal amplifier. The second power supply may be a keep-alive power supply. The CIU may include at least one CAN (Controller Area Network) physical layer interface and at least one J1850 physical layer interface. The CIU may be configured as a Class 2 Series communication device.

In accordance with yet another aspect of the present invention, a method for reducing power consumption by a telematic terminal on board a vehicle comprises:
turning off a telematic terminal controller to save power after the vehicle ignition is turned off;
driving only the cores of a NAD (Network Access Device) processor and a RF (Radio Frequency) module for a first pre-set period of time in a power saving mode;
checking whether the first pre-set period of time has elapsed;
changing into a reception standby state from the power saving mode if the first pre-set period of time has elapsed, the NAD processor and the RF module operating normally during the reception standby state for a second pre-set period of time;
checking whether the second pre-set period of time has elapsed;
checking whether the vehicle ignition has been turned on if the second pre-set period of time has elapsed; and
turning on the telematic terminal controller if the vehicle ignition has been turned on. The turned on telematic terminal controller terminates the reception standby state.

The method further comprises changing into the power saving mode again if the vehicle ignition has not been turned on.

In accordance with still another aspect of the present invention, a method for reducing power consumption by a telematic terminal on board a vehicle comprises:
turning off a telematic terminal controller to save power after the vehicle ignition is turned off;
driving a RTC (Real-Time Clock) unit;
driving only the cores of a NAD (Network Access Device) processor, a RF (Radio Frequency) module, and a PMIC (Power Management Integrated Circuit) for a first pre-set period of time in a power saving mode, the RTC unit being integrated in the PMIC;
checking whether the first pre-set period of time has elapsed;
transmitting real-time information from the PMIC to the NAD processor if the first pre-set period of time has elapsed;
changing into a reception standby state from the power saving mode, the NAD processor, the RF module, and the PMIC operating normally during the reception standby state for a second pre-set period of time;
checking whether the second pre-set period of time has elapsed;
checking whether the vehicle ignition has been turned on if the second pre-set period of time has elapsed; and
turning on the telematic terminal controller if the vehicle ignition has been turned on. The turned on telematic terminal controller terminates the reception standby state.

The method further comprises changing into the power saving mode again if the vehicle ignition has not been turned on.

These and other aspects of the present invention will become apparent from a review of the accompanying drawings and the following detailed description of the present invention.

### BRIEF DESCRIPTION OF THE DRAWINGS

The present invention is generally shown by way of reference to the accompanying drawings as follows.

FIG. 1 is a block diagram of a conventional telematic terminal.

FIG. 2 is a block diagram of a telematic terminal in accordance with one embodiment of the present invention.

FIG. 3 is an exemplary operational flow chart of the telematic terminal of FIG. 2.

FIG. 4 is a block diagram of a telematic terminal in accordance with another embodiment of the present invention.

FIG. 5 is an exemplary operational flow chart of the telematic terminal of FIG. 4.

### DETAILED DESCRIPTION OF THE PREFERRED EMBODIMENTS

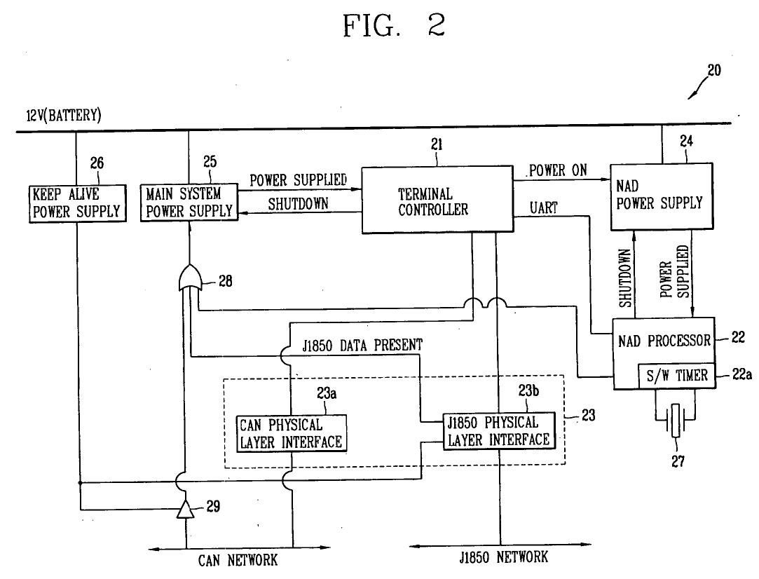

Some embodiments of the present invention will be described in detail with reference to the related drawings of FIGS. 2-5. Additional embodiments, features and/or advantages of the invention will become apparent from the ensuing description or may be learned by practicing the invention.

In the figures, the drawings are not to scale with like numerals referring to like features throughout both the drawings and the description.

The following description includes the best mode presently contemplated for carrying out the invention. This description is not to be taken in a limiting sense, but is made merely for the purpose of describing the general principles of the invention.

FIGS. 2-5 generally depict a system and method for reducing power consumption by a telematic terminal in accordance with the general principles of the present invention. FIG. 2 is a block diagram of a telematic terminal 20 in accordance with one embodiment of the present invention.

Telematic terminal 20 includes a terminal controller 21, a NAD processor 22, a NAD power supply 24, and a CIU (Communication Interface Unit) 23. CIU 23 includes a CAN (Controller Area Network) physical layer interface 23a and a J1850 physical layer interface 23b, and is configured as a Class 2 Series communication device. NAD processor 22 is configured to process various call signals between a base station and the terminal using mobile (wireless) communication technology, as well as modulate/demodulate data signals. Terminal controller 21 is operatively coupled between CIU 23 and NAD processor 22, and is powered by a main power supply 25. NAD power supply 24 is turned on by terminal controller 21 (FIG. 2).

Terminal controller 21 communicates with NAD processor 22 via a UART connection. A software (S/W) timer 22a in NAD processor 22 is driven by a clock oscillator 27 (FIG. 2). A keep-alive power supply 26 supplies power to CIU 23 and a communication signal amplifier 29. Main power supply 25 is controlled by a communication signal combiner 28 which receives input from CIU 23, communication signal amplifier 29, and NAD processor 22. NAD processor 22 may be implemented as a modem adapted for mobile communication, also referred to as MSM (Mobile Station Modem).

When the ignition of a vehicle equipped with telematic terminal 20 is turned off, terminal controller 21 is completely turned off. With ignition being turned off, NAD processor 22 drives software timer 22a based on time information transmitted from the base station (not shown) and clock oscillator 27, which is operatively coupled to NAD processor 22. By using its internal software timer 22a, NAD processor 22 drives itself and a RF module (not shown) for a predetermined initial period of time (e.g., one minute) with on-board telematic terminal 20 operating in a reception standby state. On-board telematic terminal 20 drives only the NAD processor core and the RF module core for a predetermined final period of time (e.g., nine minutes) to save power, i.e. on-board telematic terminal 20 is in a power saving mode.

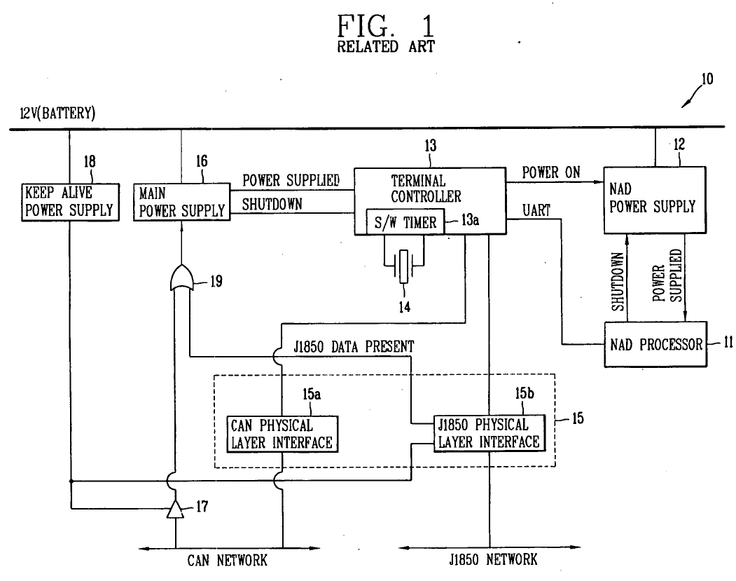

If on-board telematic terminal 20 is located in an analog service region where time information cannot be obtained from a base station, software timer 22a uses time input from a satellite through an integral GPS module. With NAD processor 22 and the RF module being in a reception standby state for one minute, and only the cores of NAD processor 22 and the RF module being driven in a power saving mode for the remaining nine minutes, the overall amount of current being consumed is significantly reduced (compared to the telematic setup of FIG. 1), since terminal controller 21 is completely turned off.

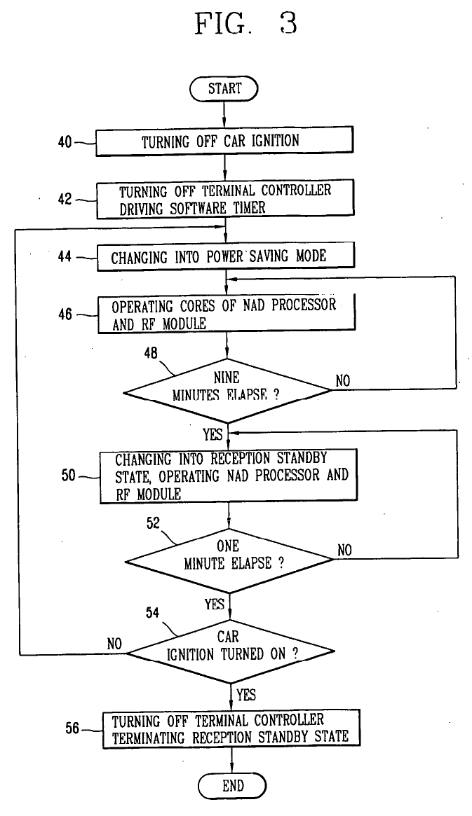

FIG. 3 is an exemplary operational flow chart of telematic terminal 20. When the ignition of a car equipped with an on-board telematic terminal, such as terminal 20, is turned off (step 40), terminal controller 21 is completely turned off, with software timer 22a operating on the basis of time information received from a CDMA/PCS base station (not shown) (step 42). While software timer 22a is operative, on-board telematic terminal 20 goes into a power saving mode (step 44). In the power saving mode, only the NAD processor core and the RF module core are being driven (step 46).

If the power saving mode lasts longer than a pre-set period of time, e.g. nine minutes (step 48), on-board telematic terminal 20 changes into a reception standby state (step 50), in which NAD processor 22 and the RF module operate normally. If the power saving mode does not last longer than the pre-set period of time, on-board telematic terminal 20 remains in power saving mode and repeats step 46 (FIG. 3).

If the reception standby state lasts longer than a pre-set period of time, e.g. one minute (step 52), on-board telematic terminal 20 checks whether the car ignition has been turned on (step 54). If the reception standby state does not last longer than the pre-set period of time, on-board telematic terminal 20 repeats step 50 (FIG. 3).

If the ignition has not been turned on, on-board telematic terminal 20 changes into power saving mode again, i.e. repeats step 44. If the ignition is turned on, the reception standby state of on-board telematic terminal 20 is terminated, and terminal controller 21 is turned on (step 56). A person skilled in the art would readily appreciate that the above-identified time periods may be adjusted, as necessary. A person skilled in the art would also appreciate that telematic terminal 20 advantageously reduces overall power consumption by completely turning terminal controller 21 off after the car ignition has been turned off. Consequently, only NAD processor 22 and the RF module (not shown) are periodically turned on to receive signals from the base station according to the general principles of the present invention.

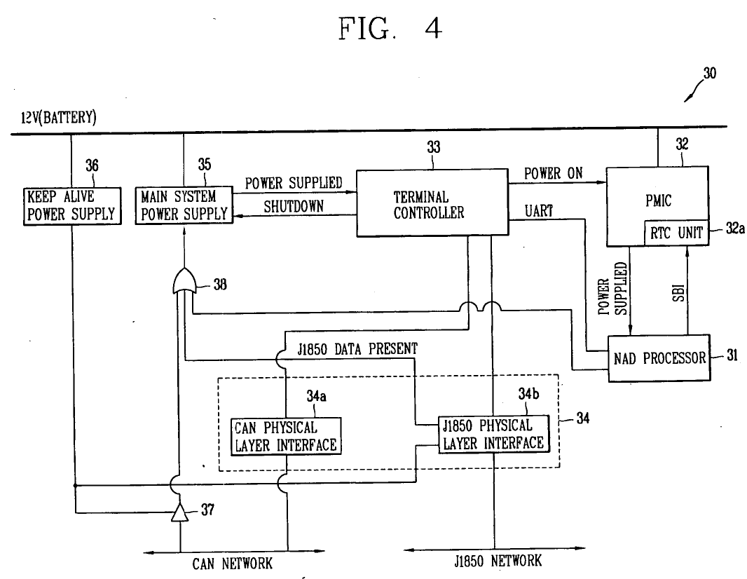

FIG. 4 is a block diagram of a telematic terminal 30 in accordance with another embodiment of the present invention. Telematic terminal 30 includes a terminal controller 33, a NAD processor 31, a PMIC (Power Management Integrated Circuit) 32, and a CIU (Communication Interface Unit) 34. CIU 34 includes a CAN (Controller Area Network) physical layer interface 34a and a J1850 physical layer interface 34b, and is configured as a Class 2 Series communication device. Terminal controller 33 is operatively coupled between CIU 34 and NAD processor 31, and is powered by a main power supply 35.

PMIC 32 supplies power to terminal controller 33 and includes a RTC (Real-Time Clock) unit 32a. PMIC 32 is turned on by terminal controller 33 (FIG. 4). PMIC 32 includes a plurality of power regulators which control the supply power to NAD processor 31 and a RF module (not shown). PMIC 32 drives RTC unit 32a based on time information received from NAD processor 31 and a clock oscillator (not shown) operatively coupled to PMIC 32. NAD processor 22 is configured to process various call signals between a base station and the terminal using mobile (wireless) communication technology, as well as modulate/demodulate data signals. NAD processor 31 periodically changes the mode of operation of telematic terminal 30 from reception standby state to power saving mode on the basis of real-time information received from RTC unit 32a.

Terminal controller 33 communicates with NAD processor 31 via a UART connection. A keep-alive power supply 36 supplies power to CIU 34 and a communication signal amplifier 37. Main power supply 35 is controlled by a communication signal combiner 38 which receives input from CIU 34, communication signal amplifier 37, and NAD processor 31. NAD processor 31 may be implemented as a modem adapted for mobile communication, also referred to as MSM (Mobile Station Modem).

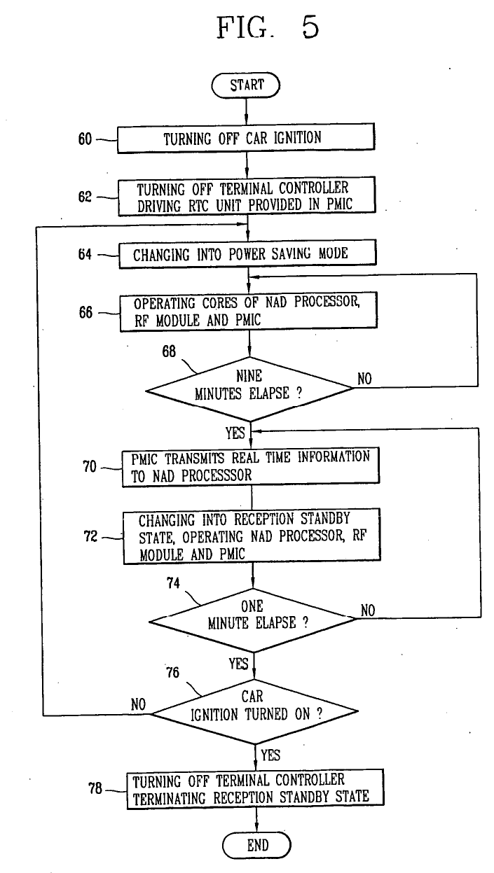

FIG. 5 is an exemplary operational flow chart of telematic terminal 30. When the ignition of a car equipped with an on-board telematic terminal, such as terminal 30, is turned off (step 60), terminal controller 33 is completely turned off (step 62). NAD processor 31 transmits time information received from a base station (not shown) to PMIC 32 which presets RTC unit 32a. RTC unit 32a is driven according to the transmitted time information, and on-board telematic terminal 30 goes into a power saving mode (step 64) with the exception of RTC unit 32a. In the power saving mode, only the NAD processor core, the RF module core and the PMIC core are being driven (step 66).

If the power saving mode lasts longer than a pre-set period of time, e.g. nine minutes (step 68), PMIC 32 transmits real-time information to NAD processor 31 (step 70), which is turned on. Consequently, on-board telematic terminal 30 changes into a reception standby state (step 72), in which NAD processor 31, the RF module and PMIC 32 operate normally. If the power saving mode does not last longer than the pre-set period of time, on-board telematic terminal 30 remains in power saving mode and repeats step 66 (FIG. 5).

If the reception standby state lasts longer than a pre-set period of time, e.g. one minute (step 74), on-board telematic terminal 30 checks whether the car ignition has been turned on (step 76). If the reception standby state does not last longer than the pre-set period of time, on-board telematic terminal 30 repeats steps 70 and 72 (FIG. 5).

If the ignition has not been turned on, on-board telematic terminal 30 changes into power saving mode again, i.e. repeats step 64. If the ignition is turned on, the reception standby state of on-board telematic terminal 30 is terminated, and terminal controller 33 is turned on (step 78).

A person skilled in the art would readily appreciate that the above-identified time periods may be adjusted, as necessary. A person skilled in the art would also appreciate that power consumption used to operate terminal controller 33 in the reception standby state, as practiced in the telematic setup of FIG. 1, is completely eliminated, thereby minimizing battery consumption of telematic terminal 30 and extending its life.

When the car ignition is turned off, terminal controller 33 is completely turned off. Subsequently, only NAD processor 31 and the RF module are turned on periodically to receive communication signals from the base station.

All terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

While the present invention has been described in detail with regards to several embodiments, it should be appreciated that various modifications and variations may be made in the present invention without departing from the scope or spirit of the invention. In this regard it is important to note that practicing the invention is not limited to the applications described hereinabove.

Many other applications and/or alterations may be utilized provided that such other applications and/or alterations do not deviate from the intended purpose of the present invention. Also, features illustrated or described as part of one embodiment can be used in another embodiment to provide yet another embodiment such that the features are not limited to the embodiments described above. Thus, it is intended that the present invention cover all such embodiments and variations as long as such embodiments and variations come within the scope of the appended claims and their equivalents.

1. A system for reducing power consumption by a telematics terminal which is provided in a vehicle, exchanges various radio data with a base station while the vehicle is moving and changes a mode of the telematics terminal into a reception standby power saving mode when the ignition of the vehicle is turned off, comprising:
a control unit turned off in the reception standby power saving mode;
a modem for mobile communication for receiving time information from the base station and periodically operating in a reception standby state or a power saving mode according to real-time information;
a clock oscillator for driving a timer which calculates real-time information; and
a signal combining unit for combining a signal applied from a communication interface unit with a power control signal applied from the modem for mobile communication to control a main system power supply unit.

2. The system of claim 1, wherein the reception standby power saving mode comprises:
a reception standby state in which a signal received from a base station is searched for a first time duration;
a power saving mode in which a signal of the base station is not searched for a second time duration.

3. The system of claim 1, wherein the timer is provided in the NAD processor.

4. The system of claim 1, wherein the timer is provided in the PMIC (Power Management Integrated Circuit).

5. A system for reducing power consumption by a telematic terminal, said system comprising:
a NAD (Network Access Device) processor having at least one processor core;
a CIU (Communication Interface Unit); and
a telematic terminal controller operatively coupled between said CIU and said NAD processor on board a vehicle, said telematic terminal controller and said at least one NAD processor core configured to be turned off and driven, respectively, in a power saving mode when the vehicle ignition is turned off, said power saving mode adapted to change into a signal reception standby state after a pre-set period of time, said NAD processor adapted to operate normally during said signal reception standby state.

6. The system of claim 5, wherein only said at least one NAD processor core and an associated RF (Radio Frequency) module core are driven for said pre-set period of time when the vehicle ignition is turned off.

7. The system of claim 6, further comprising a first power supply adapted to power said telematic terminal controller.

8. The system of claim 7, wherein said first power supply is controlled by a communication signal combiner, said communication signal combiner receiving input from said CIU, said NAD processor and at least one communication signal amplifier.

9. The system of claim 8, further comprising a second power supply adapted to power said NAD processor, said second power supply being turned on by said telematic terminal controller.

10. The system of claim 9, wherein said NAD processor includes a software timer being driven by a clock oscillator.

11. The system of claim 10, wherein said clock oscillator is operatively coupled to said NAD processor.

12. The system of claim 11, wherein said NAD processor drives said software timer based on time information transmitted from a base station and said clock oscillator during said power saving mode.

13. A system for reducing power consumption by a telematic terminal, said system comprising:
a NAD (Network Access Device) processor having a core;
a CIU (Communication Interface Unit);
a PMIC (Power Management Integrated Circuit) having a core; and
a telematic terminal controller operatively coupled between said CIU and said NAD processor on board a vehicle and being powered by said PMIC, said telematic terminal controller and said NAD and PMIC cores configured to be turned off and driven, respectively, in a power saving mode when the vehicle ignition is turned off, said power saving mode adapted to change into a signal reception standby state after a pre-set period of time, said NAD processor and said PMIC adapted to operate normally during said signal reception standby state.

14. The system of claim 13, wherein only said NAD and PMIC cores and an associated RF (Radio Frequency) module core are driven for said pre-set period of time when the vehicle ignition is turned off.

15. The system of claim 13, wherein said PMIC includes a RTC (Real-Time Clock) unit.

16. The system of claim 15, wherein said PMIC is turned on by said telematic terminal controller.

17. The system of claim 16, wherein said PMIC drives said RTC unit based on time information received from said NAD processor and a clock oscillator being operatively coupled to said PMIC.

18. The system of claim 13, wherein said NAD processor is configured to periodically change said reception standby state to said power saving mode on the basis of real-time information received from said RTC unit.

19. The system of claim 13, wherein said telematic terminal controller communicates with said NAD processor via a UART (Universal Asynchronous Receiver Transmitter) connection.

20. The system of claim 17, further comprising a first power supply adapted to power said telematic terminal controller.

21. The system of claim 20, wherein said first power supply is controlled by a communication signal combiner, said communication signal combiner receiving input from said CIU, said NAD processor and at least one communication signal amplifier.

22. The system of claim 21, further comprising a second power supply adapted to power said CIU and said at least one communication signal amplifier.

23. The system of claim 22, wherein said second power supply is a keep-alive power supply.

24. The system of claim 13, wherein said CIU includes at least one CAN (Controller Area Network) physical layer interface and at least one J1850 physical layer interface.

25. The system of claim 24, wherein said CIU is configured as a Class 2 Series communication device.

26. A method for reducing power consumption by a telematic terminal on board a vehicle, said method comprising the steps of:
turning off a telematic terminal controller to save power after the vehicle ignition is turned off;
driving only the cores of a NAD (Network Access Device) processor and a RF (Radio Frequency) module for a first pre-set period of time in a power saving mode;
checking whether said first pre-set period of time has elapsed;
changing into a reception standby state from said power saving mode if said first pre-set period of time has elapsed, said NAD processor and said RF module operating normally during said reception standby state for a second pre-set period of time;
checking whether said second pre-set period of time has elapsed;
checking whether the vehicle ignition has been turned on if said second pre-set period of time has elapsed; and
turning on said telematic terminal controller if the vehicle ignition has been turned on, said turned on telematic terminal controller terminating said reception standby state.

27. The method of claim 26, further comprising the step of changing into said power saving mode again if the vehicle ignition has not been turned on.

28. A method for reducing power consumption by a telematic terminal on board a vehicle, said method comprising the steps of:
turning off a telematic terminal controller to save power after the vehicle ignition is turned off;
driving a RTC (Real-Time Clock) unit;
driving only the cores of a NAD (Network Access Device) processor, a RF (Radio Frequency) module, and a PMIC (Power Management Integrated Circuit) for a first pre-set period of time in a power saving mode, said RTC unit being integrated in said PMIC;
checking whether said first pre-set period of time has elapsed;
transmitting real-time information from said PMIC to said NAD processor if said first pre-set period of time has elapsed;
changing into a reception standby state from said power saving mode, said NAD processor, said RF module, and said PMIC operating normally during said reception standby state for a second pre-set period of time;
checking whether said second pre-set period of time has elapsed;
checking whether the vehicle ignition has been turned on if said second pre-set period of time has elapsed; and
turning on said telematic terminal controller if the vehicle ignition has been turned on, said turned on telematic terminal controller terminating said reception standby state.

29. The method of claim 28, further comprising the step of changing into said power saving mode again if the vehicle ignition has not been turned on.
